(19) United States
(12) Patent Application Publication
(10) Pub. No.: US 2025/0102673 A1
(43) Pub. Date: Mar. 27, 2025

(54) APPARATUS FOR RECOGNIZING OBJECT AND METHOD THEREOF

(71) Applicants: Hyundai Motor Company, Seoul (KR); Kia Corporation, Seoul (KR)

(72) Inventor: Jun Young PARK, Seoul (KR)

(73) Assignees: Hyundai Motor Company, Seoul (KR); Kia Corporation, Seoul (KR)

(21) Appl. No.: 18/632,944

(22) Filed: Apr. 11, 2024

(30) Foreign Application Priority Data
Sep. 26, 2023 (KR) 10-2023-0129540

(51) Int. Cl. G01S 17/89; G01S 17/08; G01S 17/931

(52) U.S. Cl. CPC G01S 17/89; G01S 17/08; G01S 17/931

(57) ABSTRACT

In an object recognition apparatus and method, the object recognition apparatus includes a LiDAR and a processor. The processor may identify a first point, a second point, a third point, and a fourth point, identify a first external point, and a second external point, identify an angle between a line segment connecting the first external point and the LiDAR and a line segment connecting the second external point and the LiDAR identify, as an occluded object, an object which is one of the first object and the second object, when the angle is less than or equal to a threshold angle, and identify an object different from the object identified as the occluded object among the first object and the second object as an object occluding the occluded object.

### CROSS-REFERENCE TO RELATED APPLICATION

The present application claims priority to Korean Patent Application No. 10-2023-0129540, filed on Sep. 26, 2023, the entire contents of which is incorporated herein for all purposes by this reference.

### BACKGROUND OF THE PRESENT DISCLOSURE

### Field of the Present Disclosure

The present disclosure relates to an object recognition apparatus and method, and more particularly, to a technique for identifying characteristics of an object represented by a point could obtained through a light detection and ranging (LiDAR).

### Description of Related Art

Technology for detecting surrounding environments and distinguishing between obstacles is required for an autonomous vehicle or a vehicle with activated driver assistance devices to adjust its driving path and avoid obstacles with minimal driver intervention.

A vehicle may obtain data indicating the position of an object around the vehicle through a Light Detection and Ranging (LiDAR). A distance from a LiDAR to an object may be obtained through an interval between the time when laser is transmitted by the LiDAR and the time when the laser reflected by the object is received. A vehicle may identify the location of a point included outside of the object in a space where the vehicle is located, based on the angle of the transmitted laser and the distance to the object.

The autonomous vehicle or the vehicle with an activated driver assistance device may identify the information of an object represented by the points, based on the position information of obtained points.

The information included in this Background in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an object recognition apparatus and method for identifying whether an object represented by a point cloud is an object that occludes another object or an object which is occluded by another object.

Various aspects of the present disclosure are directed to providing an object recognition apparatus and method for improving the accuracy of determination of whether an object represented by a point cloud is an object that occludes another object or an object which is occluded by another object by comparing reliability values of a plurality of objects represented by a point cloud.

Various aspects of the present disclosure are directed to providing an object recognition apparatus and method for improving the accuracy of determination of whether an object represented by a point cloud is an object that occludes another object or an object which is occluded by another object by comparing distances from a LiDAR to external points of an object.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an object recognition apparatus may include a LiDAR and a processor.

According to an exemplary embodiment of the present disclosure, the processor may identify a first point which is a leftmost point with respect to a host vehicle among a point cloud obtained through the LiDAR and representing a first object, a second point which is a rightmost point with respect to the host vehicle among the point cloud representing the first object, a third point which is a leftmost point with respect to the host vehicle among a point cloud representing a second object, and a fourth point which is a rightmost point with respect to the host vehicle among the point cloud representing the second object, identify a first external point, which is closer to the second object, which is one of the first point and the second point, and a second external point, which is closer to the first object, which is one of the third point and the fourth point, identify an angle between a line segment connecting the first external point and the LiDAR and a line segment connecting the second external point and the LiDAR based on identifying that the first external point and the second external point do not overlap each other, identify, as an occluded object, an object which is one of the first object and the second object, which corresponds to one of the first external point and the second external point which forms a longer distance among a distance between the first external point and the LiDAR and a distance between the second external point and the LiDAR, when the angle is less than or equal to a threshold angle, and identify an object different from the object identified as the occluded object among the first object and the second object as an object occluding the occluded object.

According to an exemplary embodiment of the present disclosure, the processor may assign a reliability to the first object and assign a reliability to the second object with a value different from the reliability according to a distance between a straight line connecting the first point and the second point and the LiDAR, and a distance between a straight line connecting the third point and the fourth point and the LiDAR based on identifying that the first external point and the second external point overlap each other. The reliability assigned to the first object and the reliability assigned to the second object may indicate whether a corresponding object is an object that occludes another object.

According to an exemplary embodiment of the present disclosure, the processor may identify a point cloud representing at least one of the first object and the second object identified in a plane formed by a first axis and a second axis among the first axis, the second axis, and a third axis, and identify whether the first external point and the second external point overlap each other, based on identifying that an azimuth angle of the first external point with respect to an origin corresponding to the LiDAR and the first axis is included in a range between an azimuth angle of the third point with respect to the origin and the first axis and an azimuth angle of the fourth point with respect to the origin and the first axis.

According to an exemplary embodiment of the present disclosure, the processor may identify a straight line passing through the first point and the second point, according to coordinates of the first point and coordinates of the second point based on identifying that the first external point and the second external point overlap each other, assign a reliability to the second object as much as a number of the third points or the fourth points included in an area to which the LiDAR belongs among two areas separated by the straight line, identify a straight line passing through the third point and the fourth point according to coordinates of the third point and coordinates of the fourth point, assign a reliability to the first object including a different value from the reliability as much as a number of the first points or the second points which are included in an area to which the LiDAR belongs among two areas separated by the straight line passing through the third point and the fourth point, and identify an object with a greater reliability value as an object that occludes another object by comparing a value of the reliability of the first object and a value of the reliability of the second object.

According to an exemplary embodiment of the present disclosure, the processor may identify a first function which is a function of a straight line passing through the first point and the second point, according to coordinates of the first point and coordinates of the second point based on identifying that the first external point and the second external point overlap each other, assign a reliability to the second object as much as a number of the same signs as a sign of a value obtained by substituting coordinates of an origin corresponding to the LiDAR into the first function, among a sign of a value obtained by substituting coordinates of the third point into the first function and a sign of a value obtained by substituting coordinates of the fourth point into the first function, identify a second function which is a function of a straight line passing through the third point and the fourth point according to the coordinates of the third point and the coordinates of the fourth point, assign a reliability to the first object as much as a number of the same signs as a sign of a value obtained by substituting the coordinates of the origin corresponding to the LiDAR into the second function, among a sign of a value obtained by substituting the coordinates of the first point into the second function and a sign of a value obtained by substituting the coordinates of the second point into the second function, and identify an object with a greater reliability value as an object that occludes another object by comparing a value of the reliability of the first object and a value of the reliability of the second object.

According to an exemplary embodiment of the present disclosure, the processor may identify a fan-shaped area including a point cloud included in a specific layer and representing the first object which is located to leftmost with respect to the host vehicle and a point cloud included in the specific layer and representing the second object which is located to rightmost with respect to the host vehicle, the fan-shaped area including a minimum center angle with respect to a origin corresponding to the LiDAR, and expand an area of the fan-shaped area by increasing the center angle of the fan-shaped area to include at least one point located outside the fan-shaped area, based on identifying that the at least one point of a point cloud included in a plurality of layers including the specific layer and representing the first object, and a point cloud included in the plurality of layers including the specific layer and representing the second object is located outside of the fan-shaped area.

According to an exemplary embodiment of the present disclosure, the processor may identify a fan-shaped area including a point cloud representing the first object which is located to leftmost with respect to the host vehicle and a point cloud representing the second object which is located to rightmost with respect to the host vehicle, including a minimum center angle with respect to a origin corresponding to the LiDAR, identify a fifth point located to the leftmost with respect to the host vehicle among a point cloud representing a third object and a sixth point located to the rightmost with respect to the host vehicle among a point cloud representing the third object, identify a left angle between a line segment representing a left boundary of the fan-shaped area and a line segment connecting the fifth point and the LiDAR or a right angle between a line segment representing a right boundary of the fan-shaped area and a line segment connecting the sixth point and the LiDAR, and identify the third object as being located on the left boundary or as being located on the right boundary based on the left angle or the right angle being less than or equal to a predetermined angle.

According to an exemplary embodiment of the present disclosure, the processor may identify a point cloud representing the first object among points included in a plurality of layers, and identify a point cloud representing the second object among the points included in the plurality of layers.

According to an exemplary embodiment of the present disclosure, the processor may identify the first external point and the second external point based on an angle between a line segment connecting the first point and the LiDAR and a line segment connecting the third point and the LiDAR, an angle between the line segment connecting the first point and the LiDAR and a line segment connecting the fourth point and the LiDAR, an angle between a line segment connecting the second point and the LiDAR and the line segment connecting the third point and the LiDAR, and an angle between the line segment connecting the second point and the LiDAR and the line segment connecting the fourth point and the LiDAR.

According to an exemplary embodiment of the present disclosure, the processor may identify a fourth object occluded by at least one object, and iteratively identify a fifth object occluded by the fourth object based on a table representing the occluded object and the occluding object, and the at least one object located on the left boundary or on the right boundary.

According to an aspect of the present disclosure, an object recognition method includes identifying a first point which is a leftmost point with respect to a host vehicle among a point cloud obtained through a LiDAR and representing a first object, a second point which is a rightmost point with respect to the host vehicle among the point cloud representing the first object, a third point which is a leftmost point with respect to the host vehicle among a point cloud representing a second object, and a fourth point which is a rightmost point with respect to the host vehicle among the point cloud representing the second object, identifying a first external point, which is closer to the second object, which is one of the first point and the second point, and a second external point, which is closer to the first object, which is one of the third point and the fourth point, identifying an angle between a line segment connecting the first external point and the LiDAR and a line segment connecting the second external point and the LiDAR based on identifying that the first external point and the second external point do not overlap each other, identifying, as an occluded object, an object which is one of the first object and the second object, which corresponds to one of the first external point and the second external point which forms a longer distance among a distance between the first external point and the LiDAR and a distance between the second external point and the LiDAR, when the angle is less than or equal to a threshold angle, and identifying an object different from the object identified as the occluded object among the first object and the second object as an object occluding the occluded object.

According to an exemplary embodiment of the present disclosure, the object recognition method may further include assigning a reliability to the first object and assigning a reliability to the second object with a value different from the reliability according to a distance between a straight line connecting the first point and the second point and the LiDAR, and a distance between a straight line connecting the third point and the fourth point and the LiDAR based on identifying that the first external point and the second external point overlap each other. The reliability assigned to the first object and the reliability assigned to the second object may indicate whether a corresponding object is an object that occludes another object.

According to an exemplary embodiment of the present disclosure, the object recognition method may further include identifying a point cloud representing at least one of the first object and the second object identified in a plane formed by a first axis and a second axis among the first axis, the second axis, and a third axis, and identifying whether the first external point and the second external point overlap each other, based on identifying that an azimuth angle of the first external point with respect to an origin corresponding to the LiDAR and the first axis is included in a range between an azimuth angle of the third point with respect to the origin and the first axis and an azimuth angle of the fourth point with respect to the origin and the first axis.

According to an exemplary embodiment of the present disclosure, the object recognition method may further include identifying a straight line passing through the first point and the second point, according to coordinates of the first point and coordinates of the second point based on identifying that the first external point and the second external point overlap each other, assigning a reliability to the second object as much as a number of the third points or the fourth points included in an area to which the LiDAR belongs among two areas separated by the straight line, identifying a straight line passing through the third point and the fourth point according to coordinates of the third point and coordinates of the fourth point, assigning a reliability to the first object including a different value from the reliability as much as a number of the first points or the second points which are included in an area to which the LiDAR belongs among two areas separated by the straight line passing through the third point and the fourth point, and identifying an object with a greater reliability value as an object that occludes another object by comparing a value of the reliability of the first object and a value of the reliability of the second object.

According to an exemplary embodiment of the present disclosure, the object recognition method may further include identifying a first function which is a function of a straight line passing through the first point and the second point, according to coordinates of the first point and coordinates of the second point based on identifying that the first external point and the second external point overlap each other, assigning a reliability to the second object as much as a number of the same signs as a sign of a value obtained by substituting coordinates of an origin corresponding to the LiDAR into the first function, among a sign of a value obtained by substituting coordinates of the third point into the first function and a sign of a value obtained by substituting coordinates of the fourth point into the first function, identifying a second function which is a function of a straight line passing through the third point and the fourth point according to the coordinates of the third point and the coordinates of the fourth point, assigning a reliability to the first object as much as a number of the same signs as a sign of a value obtained by substituting the coordinates of the origin corresponding to the LiDAR into the second function, among a sign of a value obtained by substituting the coordinates of the first point into the second function and a sign of a value obtained by substituting the coordinates of the second point into the second function, and identifying an object with a greater reliability value as an object that occludes another object by comparing a value of the reliability of the first object and a value of the reliability of the second object.

According to an exemplary embodiment of the present disclosure, the object recognition method may further include identifying a fan-shaped area including a point cloud included in a specific layer and representing the first object which is located to leftmost with respect to the host vehicle and a point cloud included in the specific layer and representing the second object which is located to rightmost with respect to the host vehicle, the fan-shaped area including a minimum center angle with respect to a origin corresponding to the LiDAR, and expanding an area of the fan-shaped area by increasing the center angle of the fan-shaped area to include at least one point located outside the fan-shaped area, based on identifying that the at least one point of a point cloud included in a plurality of layers including the specific layer and representing the first object, and a point cloud included in the plurality of layers including the specific layer and representing the second object is located outside of the fan-shaped area.

According to an exemplary embodiment of the present disclosure, the object recognition apparatus method may further include identifying a fan-shaped area, including a point cloud representing the first object which is located to leftmost with respect to the host vehicle and a point cloud representing the second object which is located to rightmost with respect to the host vehicle, including a minimum center angle with respect to a origin corresponding to the LiDAR, identifying a fifth point located to the leftmost with respect to the host vehicle among a point cloud representing a third object and a sixth point located to the rightmost with respect to the host vehicle among a point cloud representing the third object, identifying a left angle between a line segment representing a left boundary of the fan-shaped area and a line segment connecting the fifth point and the LiDAR or a right angle between a line segment representing a right boundary of the fan-shaped area and a line segment connecting the sixth point and the LiDAR, and identifying the third object as being located on the left boundary or as being located on the right boundary based on the left angle or the right angle being less than or equal to a predetermined angle.

According to an exemplary embodiment of the present disclosure, the identifying of the first point which is the leftmost point with respect to the host vehicle among the point cloud obtained through the LiDAR and representing the first object, the second point which is the rightmost point with respect to the host vehicle among the point cloud representing the first object, the third point which is the leftmost point with respect to the host vehicle among the point cloud representing the second object, and the fourth point which is the rightmost point with respect to the host vehicle among the point cloud representing the second object may include identifying a point cloud representing the first object among points included in a plurality of layers, and identifying a point cloud representing the second object among the points included in the plurality of layers.

According to an exemplary embodiment of the present disclosure, the identifying of the first external point, which is closer to the second object, which is one of the first point and the second point, and the second external point, which is closer to the first object, which is one of the third point and the fourth point may include identifying the first external point and the second external point based on an angle between a line segment connecting the first point and the LiDAR and a line segment connecting the third point and the LiDAR, an angle between the line segment connecting the first point and the LiDAR and a line segment connecting the fourth point and the LiDAR, an angle between a line segment connecting the second point and the LiDAR and the line segment connecting the third point and the LiDAR, and an angle between the line segment connecting the second point and the LiDAR and the line segment connecting the fourth point and the LiDAR.

According to an exemplary embodiment of the present disclosure, the object recognition apparatus method may further include identifying a fourth object occluded by at least one object, and iteratively identify a fifth object occluded by the fourth object based on a table representing the occluded object and the occluding object, and the at least one object located on the left boundary or on the right boundary.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing an object recognition apparatus according to an exemplary embodiment of the present disclosure.

FIG. 2 shows a flowchart of operation of an object recognition apparatus for determining whether an object is an occluding object or an occluded object, in the object recognition apparatus or the object recognition method according to an exemplary embodiment of the present disclosure;

FIG. 3 shows an example of external points which may overlap each other in an object recognition apparatus or an object recognition method according to an exemplary embodiment of the present disclosure;

FIG. 4 shows a flowchart of operation of an object recognition apparatus for identifying an object occluded by an object located on a left or right boundary, based on a fan-shaped area, in the object recognition apparatus or the object recognition method according to an exemplary embodiment of the present disclosure;

FIG. 5 shows an example of area expansion of a fan-shaped area performed based on external points in an object recognition apparatus or an object recognition method according to an exemplary embodiment of the present disclosure;

FIG. 6 illustrates an example of determination for identifying whether an object is occluding another object or is occluded by another object when external points do not overlap each other, in an object recognition apparatus or an object recognition method according to an exemplary embodiment of the present disclosure;

FIG. 7 illustrates an example of determination for identifying whether an object is occluding another object or is occluded by another object when external points overlap each other, in an object recognition apparatus or an object recognition method according to an exemplary embodiment of the present disclosure;

FIG. 8 shows another example of determination for identifying whether an object is occluding another object or is occluded by another object when external points overlap each other, in an object recognition apparatus or an object recognition method according to an exemplary embodiment of the present disclosure;

FIG. 9 illustrates an example of iterative determination for identifying whether an object is occluding another object or is occluded by another object in an object recognition apparatus or an object recognition method according to an exemplary embodiment of the present disclosure;

FIG. 10 shows a flowchart of operation of an object recognition apparatus for identifying whether an object is occluding another object or is occluded by another object when external points do not overlap each other, in the object recognition apparatus or the object recognition method according to an exemplary embodiment of the present disclosure;

FIG. 11 shows an example of comparing the accuracy of determination for an occluding object identified based on an existing object recognition apparatus or an object recognition method and the accuracy of determination for an occluding object identified based on an object recognition apparatus or an object recognition method according to an exemplary embodiment of the present disclosure;

FIG. 12 shows an example of an amount of computation identified based on an existing object recognition apparatus or an object recognition method and an example of an amount of computation identified based on an object recognition apparatus or an object recognition method according to an exemplary embodiment of the present disclosure; and

FIG. 13 shows a determining system related to an object recognition apparatus or an object recognition method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, include the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Furthermore, the terms “unit”, “device”, “member”, “body”, or the like used hereinafter may indicate at least one shape structure or may indicate a unit of processing a function.

Furthermore, in embodiments of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. Furthermore, ‘A’ to ‘B’ means at least one of elements from A (including A) to B (including B).

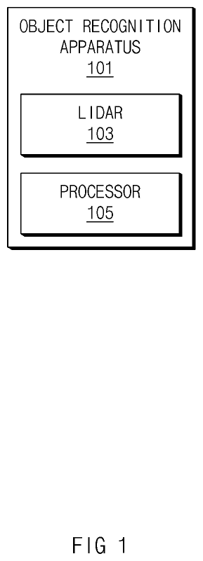

Hereinafter, various exemplary embodiments of the present disclosure will be described in detail with reference to FIGS. 1 to 13.

FIG. 1 is a block diagram showing an object recognition apparatus according to an exemplary embodiment of the present disclosure.

Referring to FIG. 1, an object recognition apparatus 101 according to an exemplary embodiment of the present disclosure may be implemented inside a vehicle. In the instant case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a LiDAR 103 and a processor 105.

According to an exemplary embodiment of the present disclosure, the processor 105 of the object recognition apparatus 101 may obtain a point cloud representing an object through the LiDAR 103.

According to an exemplary embodiment of the present disclosure, the point cloud may represent a set of points corresponding to points of a portion of an object obtained through the LiDAR 103. Each point forming the point cloud may include position information of a corresponding point of the object.

According to an exemplary embodiment of the present disclosure, the processor 105 of the object recognition apparatus 101 may identify a plurality of objects based on the point cloud. The processor 105 of the object recognition apparatus 101 may identify a first point which is the leftmost point with respect to the host vehicle in a point cloud representing a first object and a second point which is the rightmost point with respect to the host vehicle in the point cloud representing the first object. The processor of the object recognition apparatus may identify a third point which is the leftmost point with respect to the host vehicle in a point cloud representing a second object and a fourth point which is the rightmost point with respect to the host vehicle in the point cloud representing the second object.

According to an exemplary embodiment of the present disclosure, the processor 105 of the object recognition apparatus 101 may identify a first external point, which is closer to the second object, which is one of the first point and the second point. The processor 105 of the object recognition apparatus 101 may identify a second external point, which is closer to the first object which is one of the third point and the fourth point.

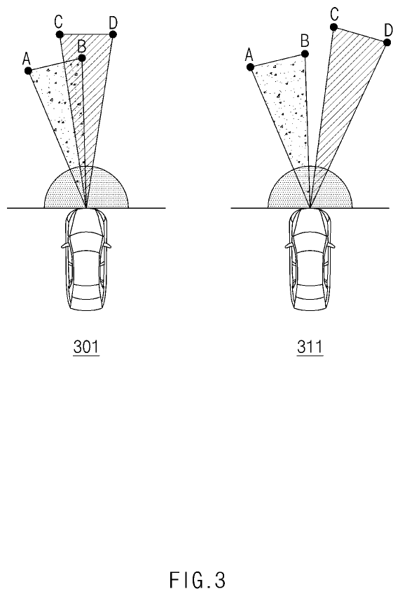

According to an exemplary embodiment of the present disclosure, the processor 105 of the object recognition apparatus 101 may identify whether the first external point and the second external point overlap each other. A method for identifying whether a first external point and a second external point overlap each other will be described with reference to FIG. 3.

When the first external point and the second external point overlap each other, the processor 105 of the object recognition apparatus 101 may identify the reliability of the first object and the reliability of the second object based on a distance from a straight line connecting the first point and the second point to the LiDAR 103, and a distance from a straight line connecting the third point and the fourth point to the LiDAR 103. For example, the longer the distances between the straight line and the LiDAR 103, the processor of the object recognition apparatus may assign a lower reliability to an object corresponding to the straight line.

The processor 105 of the object recognition apparatus 101 may identify whether the first object is an object that occludes another object, or whether the first object is an object which is occluded by another object based on the reliability assigned to the first object and the reliability assigned to the second object. The processor 105 of the object recognition apparatus 101 may identify whether the second object is an object that occludes another object, or whether the second object is an object which is occluded by another object based on the reliability assigned to the first object and the reliability assigned to the second object. For example, an object with a greater reliability among the first object and the second object may be an object that occludes another object.

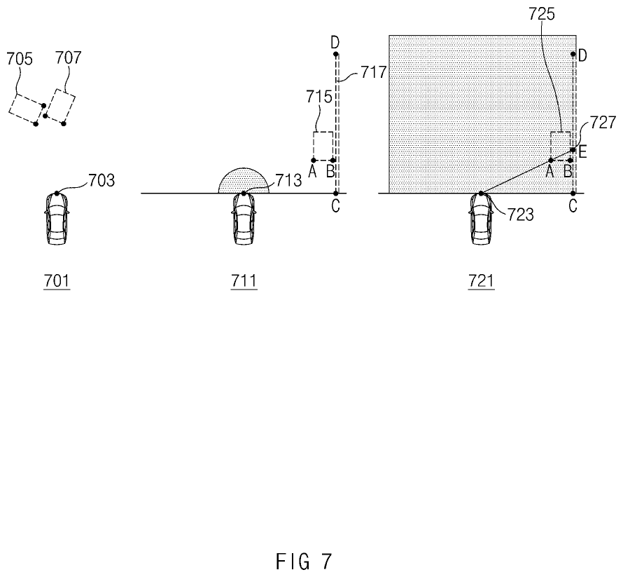

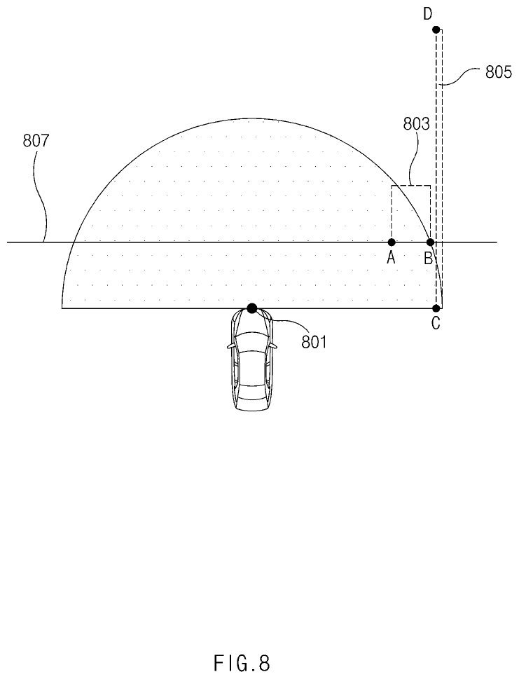

A method of identifying whether an object is occluding another object or identifying whether an object is occluded by another object when the first external point and the second external point overlap each other will be described below with reference to FIGS. 7 and 8.

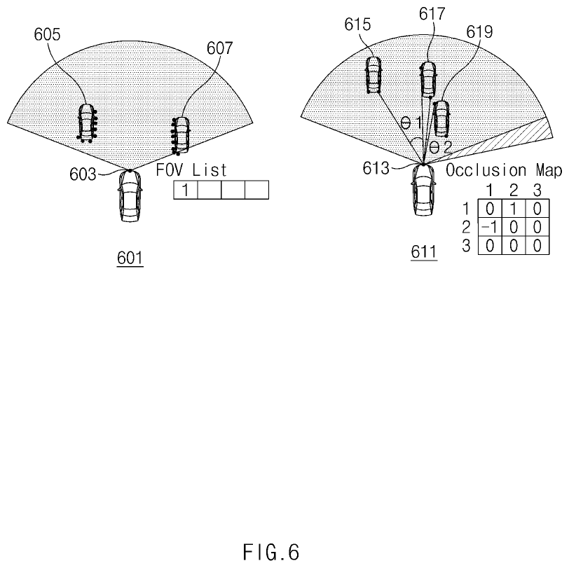

When the first external point and the second external point do not overlap each other, the processor 105 of the object recognition apparatus 101 may identify one of the first object and the second object as an occluding object, and identify the other of the first object and the second object as an occluded object based on the distance between the first external point and the LiDAR 103, and the distance between the second external point and the LiDAR 103. A method of identifying whether an object is occluding another object or identifying whether an object is occluded by another object when the first external point and the second external point do not overlap each other will be described below with reference to FIG. 6.

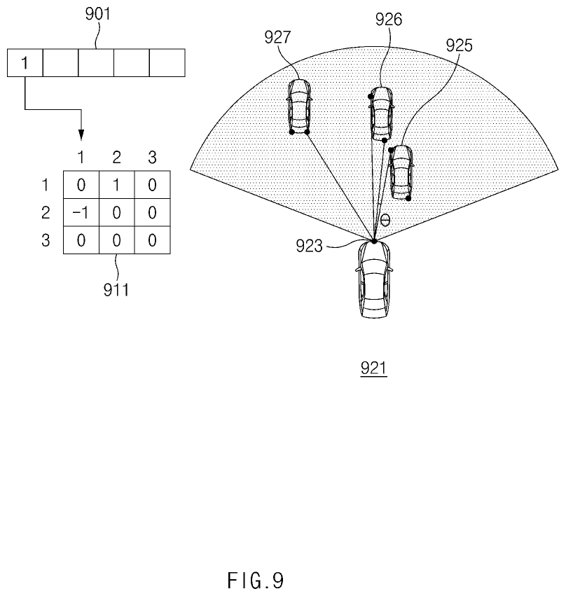

According to an exemplary embodiment of the present disclosure, the processor 105 of the object recognition apparatus 101 may store the ID of an object in a table showing an occluded object and an occluding object based on identifying the object as an occluding object. Hereinafter, the table showing an occluded object and an occluding object will be described below with reference to FIG. 9.

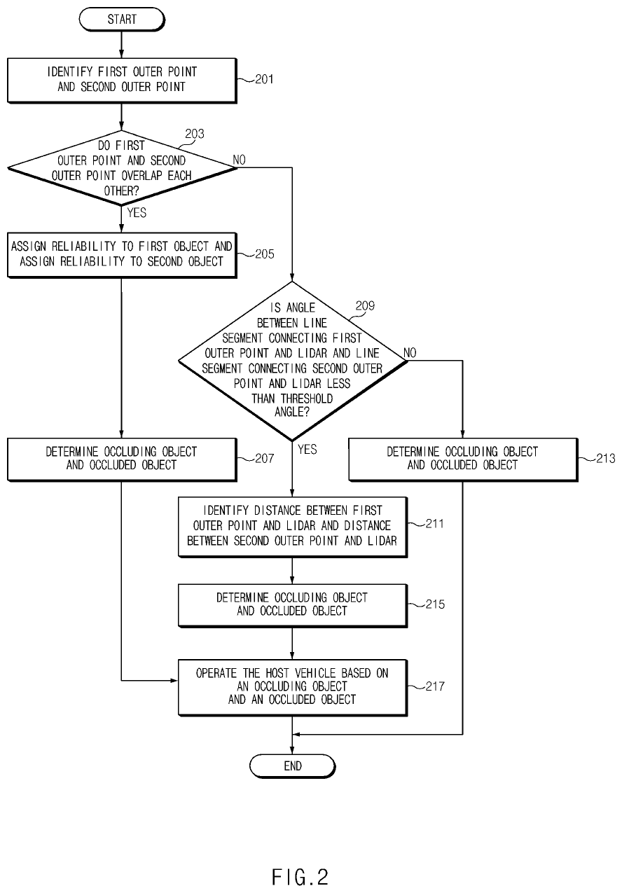

FIG. 2 shows a flowchart of operation of an object recognition apparatus for determining whether an object is an object that occludes another object, or determining whether an object is occluded by another object, in an object recognition apparatus or an object recognition method according to an exemplary embodiment of the present disclosure.

Hereinafter, it is assumed that the object recognition apparatus 101 of FIG. 1 performs the process of FIG. 2. Additionally, in the description of FIG. 2, operations described as being performed by the object recognition apparatus may be understood as being controlled by the processor 105 of the object recognition apparatus 101.

Referring to FIG. 2, in a first operation 201, the processor of the object recognition apparatus according to various exemplary embodiments of the present disclosure may identify a first external point and a second external point. To identify the first external point and the second external point, the processor of the object recognition apparatus may identify a first point, a second point, a third point, and a fourth point.

In other words, the processor of the object recognition apparatus may identify a point cloud representing at least one of a first object and a second object identified in a plane formed by a first axis and a second axis among the first axis, the second axis, and a third axis. The first axis may be referred to as the x-axis. The second axis may be referred to as the y-axis. The third axis may be referred to as the z-axis. The processor of the object recognition apparatus may identify a first point which is the leftmost point with respect to the host vehicle among a point cloud obtained via the LiDAR and representing the first object, a second point which is the rightmost point with respect to the host vehicle among the point cloud representing the first object, a third point which is the leftmost point with respect to the host vehicle among a point cloud representing the second object, and a fourth point which is the rightmost point with respect to the host vehicle among the point cloud representing the second object. The processor of the object recognition apparatus may identify a first external point, which is one of the first point and the second point that is close to the second object and a second external point, which is one of the third point and the fourth point that is close to the first object.

In a second operation 203, the processor of the object recognition apparatus according to various exemplary embodiments of the present disclosure may identify whether the first external point and the second external point overlap each other. When the first external point and the second external point overlap each other, the processor of the object recognition apparatus may perform a third operation 205. When the first external point and the second external point do not overlap each other, the processor of the object recognition apparatus may perform a fourth operation 209.

The processor of the object recognition apparatus may identify that the first external point and the second external point overlap each other, based on identifying that the azimuth angle of the first external point with respect to the origin corresponding to the LiDAR and the first axis is included in a range between the azimuth angle of the third point with respect to the origin and the first axis and the azimuth angle of the fourth point with respect to the origin and the first axis.

According to an exemplary embodiment of the present disclosure, the first axis may be referred to as the x-axis. The second axis may be referred to as the y-axis. The third axis may be referred to as the z-axis.

In a third operation 205, the processor of the object recognition apparatus according to various exemplary embodiments of the present disclosure may assign a reliability to the first object and assign a reliability to the second object.

According to an exemplary embodiment of the present disclosure, the processor of the object recognition apparatus may identify a straight line passing through the first point and the second point according to the coordinates of the first point and the coordinates of the second point based on identifying that the first external point and the second external point overlap each other. The processor of the object recognition apparatus may assign a reliability to the second object as much as the number of the third points or the fourth points which are included in an area to which the LiDAR belongs among the two areas separated by the straight line passing through the first point and the second point. The processor of the object recognition apparatus may identify a straight line passing through the third point and the fourth point, according to the coordinates of the third point and the coordinates of the fourth point. The processor of the object recognition apparatus may assign a reliability including a different value from the reliability of the second object to the first object as much as the number of the first points or the second points which are included in an area to which the LiDAR belongs among the two areas separated by the straight line passing through the third point and the fourth point.

According to another exemplary embodiment of the present disclosure, the processor of the object recognition apparatus may identify a first function which is the function of a straight line passing through the first point and the second point according to the coordinates of the first point and the coordinates of the second point based on identifying that the first external point and the second external point overlap each other. The processor of the object recognition apparatus may assign a reliability to the second object as much as the number of the same signs as the sign of a value obtained by substituting the coordinates of the origin corresponding to the LiDAR into the first function, among the sign of a value obtained by substituting the coordinates of the third point into the first function and the sign of a value obtained by substituting the coordinates of the fourth point into the first function. The processor of the object recognition apparatus may identify a second function, which is the function of a straight line passing through the third point and the fourth point, based on the coordinates of the third point and the coordinates of the fourth point. The processor of the object recognition apparatus may assign a reliability to the first object as much as the number of the same signs as the sign of a value obtained by substituting the coordinates of the origin corresponding to the LiDAR into the second function, among the sign of a value obtained by substituting the coordinates of the first point into the second function and the sign of a value obtained by substituting the coordinates of the second point into the second function.

In a fifth operation 207, the processor of the object recognition apparatus according to various exemplary embodiments of the present disclosure may be configured to determine an occluded object and an occluding object. The processor of the object recognition apparatus may compare the reliability value of the first object and the reliability value of the second object and identify an object with a high reliability value as an object that occludes another object.

In a fourth operation 209, the processor of the object recognition apparatus according to various exemplary embodiments of the present disclosure may identify whether an angle between a line segment connecting the first external point and the LiDAR and a line segment connecting the second external point and the LiDAR is less than or equal to a threshold angle. When the angle between the line segment connecting the first external point and the LiDAR and the line segment connecting the second external point and the LiDAR is less than or equal to the threshold angle, the processor of the object recognition apparatus according to various exemplary embodiments of the present disclosure may perform a sixth operation 211. When the angle between the line segment connecting the first external point and the LiDAR and the line segment connecting the second external point and the LiDAR is greater than the threshold angle, the processor of the object recognition apparatus according to various exemplary embodiments of the present disclosure may perform a seventh operation 213.

According to an exemplary embodiment of the present disclosure, the threshold angle may increase as the distance from the object to the LiDAR is shorter.

In the sixth operation 211, the processor of the object recognition apparatus according to various exemplary embodiments of the present disclosure may identify a distance between the first external point and the LiDAR and a distance between the second external point and the LiDAR.

In an eighth operation 215, the processor of the object recognition apparatus according to various exemplary embodiments of the present disclosure may be configured to determine an occluding object and an occluded object.

The processor of the object recognition apparatus may identify, as an occluded object, an object which is one of the first object and the second object which corresponds to one of the first external point and the second external point which forms a longer distance among a distance between the first external point and the LiDAR and a distance between the second external point and the LiDAR.

The processor of the object recognition apparatus may identify, as an occluding object, an object which is one of the first object and the second object which corresponds to one of the first external point and the second external point which forms a shorter distance among a distance between the first external point and the LiDAR and a distance between the second external point and the LiDAR. This is because there is a high probability that an object located close to the LiDAR occludes an object located far from the LiDAR.

In the seventh operation 213, the processor of the object recognition apparatus according to various exemplary embodiments of the present disclosure may not determine whether an object is an occluded object or an occluding object. This is because the first object does not occlude the second object, and the second object does not occlude the first object.

In a ninth operation 217, the processor of the object recognition apparatus according to various exemplary embodiments of the present disclosure may be configured to operate the host vehicle based on an occluding object and an occluded object

FIG. 3 shows an example of external points which may overlap each other in an object recognition apparatus or an object recognition method according to an exemplary embodiment of the present disclosure.

Referring to FIG. 3, in a first situation 301, the first external point of a first object (e.g., point B in the first situation 301) and the second external point of a second object (e.g., point C in the first situation 301) may overlap each other. In a second situation 311, the first external point of the first object (e.g., point B in the second situation 311) and the second external point of the second object (e.g., point C in the second situation 311) may not overlap each other.

According to an exemplary embodiment of the present disclosure, the processor of the object recognition apparatus may identify a point cloud representing at least one of a first object and a second object identified in a plane formed by the first axis and the second axis among the first axis, the second axis, and the third axis.

According to an exemplary embodiment of the present disclosure, the processor of the object recognition apparatus may identify a first point (e.g., point A in the first situation 301 or point A in the second situation 311) which is the leftmost point with respect to a host vehicle among a point cloud obtained via a LiDAR and representing the first object, a second point (e.g., point B in the first situation 301 or point B in the second situation 311) which is the rightmost point with respect to the host vehicle among the point cloud representing the first object, a third point (e.g., point C in the first situation 301 or point C in the second situation 311) which is the leftmost point with respect to the host vehicle among a point cloud representing the second object, and a fourth point (e.g., point D in the first situation 301 or point D in the second situation 311) which is the rightmost point with respect to the host vehicle among the point cloud representing the second object.

According to an exemplary embodiment of the present disclosure, the processor of the object recognition apparatus may identify a first external point (e.g., point B in the first situation 301 or point B in the second situation 311), which is one of the first point and the second point that is close to the second object and a second external point (e.g., point C in the first situation 301 or point C in the second situation 311), which is one of the third point and the fourth point that is close to the first object.

According to an exemplary embodiment of the present disclosure, the processor of the object recognition apparatus may identify that the azimuth angle of the first external point (e.g., point B in the first situation 301) with respect to the origin corresponding to the LiDAR and the first axis is included in a range between the azimuth angle of the third point (e.g., point C in the first situation 301) with respect to the origin and the first axis and the azimuth angle of the fourth point (e.g., point D in the first situation 301) with respect to the origin and the first axis to identify that the first external point (e.g., point B in the first situation 301) and the second external point (e.g., point C in the first situation 301) overlap each other.

According to an exemplary embodiment of the present disclosure, the processor of the object recognition apparatus may identify that the azimuth angle of the first external point (e.g., point B in the second situation 311) with respect to the origin corresponding to the LiDAR and the first axis is not included in the range between the azimuth angle of the third point (e.g., point C in the second situation 311) with respect to the origin and the first axis and the azimuth angle of the fourth point (e.g., point D in the second situation 311) with respect to the origin and the first axis to identify that the first external point (e.g., point B in the second situation 311) and the second external point (e.g., point C in the second situation 311) do not overlap each other.

According to an exemplary embodiment of the present disclosure, when the angle between the line segment connecting the first external point (e.g., point B in the second situation 311) and the LiDAR and the line segment connecting the second external point (e.g., point C in the second situation 311) and the LiDAR is less than or equal to a threshold angle, one of the first object and the second object may be identified as an occluded object, and the other object may be identified as an occluding object.

According to an exemplary embodiment of the present disclosure, a method of identifying an occluding object among the first object and the second object when the first external point (e.g., point B in the first situation 301) and the second external point (e.g., point C in the first situation 301) overlap each other may be different from a method of identifying an occluding object among the first object and the second object when the first external point (e.g., point B in the second situation 311) and the second external point (e.g., point C in the second situation 311) do not overlap each other.

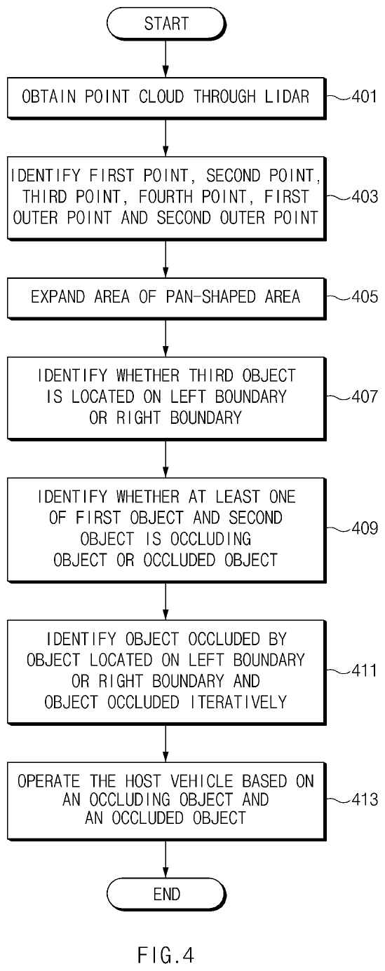

FIG. 4 shows a flowchart of operation of an object recognition apparatus for identifying an object occluded by an object located on a left or right boundary, based on a fan-shaped area, in an object recognition apparatus or an object recognition method according to an exemplary embodiment of the present disclosure.

Hereinafter, it is assumed that the object recognition apparatus 101 of FIG. 1 performs the process of FIG. 4. Additionally, in the description of FIG. 4, operations described as being performed by the object recognition apparatus may be understood as being controlled by the processor 105 of the object recognition apparatus 101.

Referring to FIG. 4, in a first operation 401, the processor of the object recognition apparatus according to various exemplary embodiments of the present disclosure may obtain a point cloud via a LiDAR.

According to an exemplary embodiment of the present disclosure, the processor of the object recognition apparatus may identify a fan-shaped area including a point cloud included in a specific layer and representing a first object which is the leftmost with respect to a host vehicle and a point cloud included in the specific layer and representing a second object which is the rightmost with respect to the host vehicle, the fan-shaped area including the minimum center angle with respect to the origin corresponding to the LiDAR. The fan-shaped area may be identified based on the point cloud included in the specific layer.

In a second operation 403, the processor of the object recognition apparatus according to various exemplary embodiments of the present disclosure may identify a first point, a second point, a third point, a fourth point, a first external point, and a second external point.

According to an exemplary embodiment of the present disclosure, the processor of the object recognition apparatus may identify a point cloud representing the first object among points included in a plurality of layers including a specific layer (e.g., all layers including points representing an object). The processor of the object recognition apparatus may identify a point cloud representing the second object among the points included in the plurality of layers including the specific layer.

According to an exemplary embodiment of the present disclosure, the processor of the object recognition apparatus may identify, as the first external point and the second external point, points forming two line segments that form the smallest angle among an angle between a line segment connecting the first point and the LiDAR and a line segment connecting the third point and the LiDAR, an angle between the line segment connecting the first point and the LiDAR and a line segment connecting the fourth point and the LiDAR, an angle between a line segment connecting the second point and the LiDAR and the line segment connecting the third point and the LiDAR, and an angle between the line segment connecting the second point and the LiDAR and the line segment connecting the fourth point and the LiDAR.

In a third operation 405, the processor of the object recognition apparatus according to various exemplary embodiments of the present disclosure may expand the area of the fan-shaped area.

The processor of the object recognition apparatus may expand the area of the fan-shaped area by increasing the center angle of the fan-shaped area to include at least one point located outside of the fan-shaped area based on identifying that the at least one point is located outside of the fan-shaped area, among a point cloud included in a plurality of layers including a specific layer and representing the first object and a point cloud included in the plurality of layers including the specific layer and representing the second object.

In a fourth operation 407, the processor of the object recognition apparatus according to various exemplary embodiments of the present disclosure may identify whether a third object is located at a left boundary or a right boundary.

According to an exemplary embodiment of the present disclosure, the processor of the object recognition apparatus may identify a fifth point located to the leftmost with respect to the host vehicle in the point cloud representing the third object, and a sixth point located to the rightmost with respect to the host vehicle in the point cloud representing the third object.

According to an exemplary embodiment of the present disclosure, the processor of the object recognition apparatus may identify a left angle between a line segment representing the left boundary of the fan-shaped area and a line segment connecting the fifth point and the LiDAR, or identify a right angle between a line segment representing the right boundary of the fan-shaped area and a line segment connecting the sixth point and the LiDAR.

According to an exemplary embodiment of the present disclosure, the processor of the object recognition apparatus may identify the third object as being located at the left boundary or the right boundary based on the left angle or the right angle being less than or equal to a predetermined angle.

According to an exemplary embodiment of the present disclosure, the processor of the object recognition apparatus may store the ID of an object located at the left boundary or the right boundary in a table.

In a fifth operation 409, the processor of the object recognition apparatus according to various exemplary embodiments of the present disclosure may identify whether at least one of the first object and the second object is an occluding object and an occluded object.

According to an exemplary embodiment of the present disclosure, the processor of the object recognition apparatus may differently perform a method of identifying whether an object is occluding another object, or is occluded by another object when a first external point and a second external point overlap each other and a method of identifying whether an object is occluding another object or is occluded by another object when a first external point and a second external point do not overlap each other.

In a sixth operation 411, the processor of the object recognition apparatus according to various exemplary embodiments of the present disclosure may identify an object which is occluded by an object on the left boundary or the right boundary and an object which is iteratively occluded.

According to an exemplary embodiment of the present disclosure, the processor of the object recognition apparatus may identify a fourth object which is occluded by at least one object, and iteratively identify a fifth object which is occluded by the fourth object based on a table representing occluded objects and occluding objects, and at least one object which is located on the left boundary or the right boundary.

For example, the processor of the object recognition apparatus may identify the fifth object occluded by the fourth object based on the table representing occluded objects and occluding objects.

In a seventh operation 413, the processor of the object recognition apparatus according to various exemplary embodiments of the present disclosure may operate the host vehicle based on an occluding object and an occluded object.

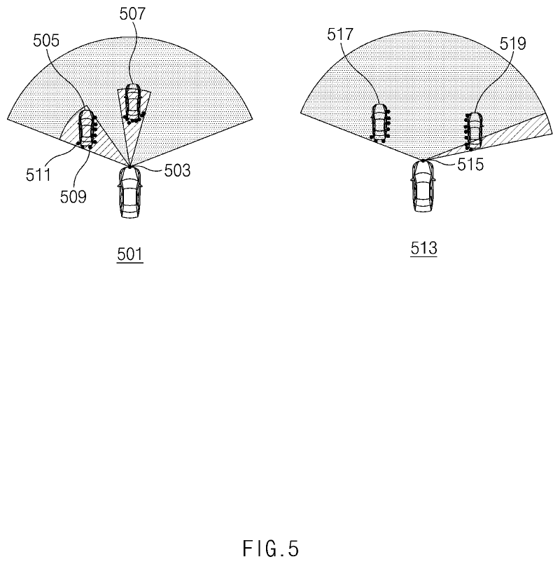

FIG. 5 shows an example of expanding area of a fan-shaped area which is performed based on external points in an object recognition apparatus or an object recognition method according to an exemplary embodiment of the present disclosure.

Referring to FIG. 5, in a first situation 501, the processor of the object recognition apparatus may identify a first point 511 which is the leftmost point with respect to a host vehicle in a point cloud 509 representing a first object 505 in the first situation 501, through a first LiDAR 503. The processor of the object recognition apparatus may identify a second point which is the rightmost point with respect to the host vehicle in the point cloud 509 representing the first object 505 in the first situation 501, through the first LiDAR 503. The processor of the object recognition apparatus may identify a third point which is the leftmost point with respect to the host vehicle in a point cloud representing a second object 507 in the first situation 501, through the first LiDAR 503 and a fourth point which is the rightmost point with respect to the host vehicle in the point cloud representing the second object 507 in the first situation 501, through the first LiDAR 503.

In a second situation 513, the processor of the object recognition apparatus may expand the area of a fan-shaped area based on a point cloud representing a first object 517 in the second situation 513 and obtained through a second LiDAR 515 and a point cloud representing a second object 519 in the second situation 513 and obtained through the second LiDAR 515.

In the first situation 501, the processor of the object recognition apparatus may identify a first point which is the leftmost point with respect to the host vehicle in the point cloud obtained through the first LiDAR 503 and representing the first object 505 in the first situation 501, a second point which is the rightmost point with respect to the host vehicle in the point cloud representing the first object 505 in the first situation 501, a third point which is the leftmost point with respect to the host vehicle in the point cloud representing the second object 507 in the first situation 501, and a fourth point which is the rightmost point with respect to the host vehicle in the point cloud representing the second object 507 in the first situation 501. The first point, the second point, the third point, and the fourth point may be referred to as an angular critical point (ACP), but embodiments of the present disclosure may not be limited thereto.

According to an exemplary embodiment of the present disclosure, the first point may include the largest azimuth angle with respect to the origin corresponding to the first LiDAR 503 and a first axis among the point cloud representing the first object 505 in the first situation 501. The second point may include the smallest azimuth angle with respect to the first axis among the point cloud representing the first object 505 in the first situation 501. The first axis may be referred to as the x-axis.

Furthermore, according to an exemplary embodiment of the present disclosure, the processor of the object recognition apparatus may identify a fan-shaped area including a point cloud included in a specific layer and representing the first object 505 in the first situation 501 which is the leftmost with respect to the host vehicle and a point cloud included in the specific layer and representing the second object 507 in the first situation 501 which is the rightmost with respect to the host vehicle, the fan-shaped area including the minimum center angle with respect to the origin corresponding to the first LiDAR 503. The fan-shaped area may be identified based on the point cloud included in the specific layer.

In the second situation 513, the processor of the object recognition apparatus may expand the area of the fan-shaped area by increasing the center angle of the fan-shaped area to include at least one point located outside of the fan-shaped area based on identifying that at least one point is located outside of the fan-shaped area, among a point cloud included in a plurality of layers including a specific layer (e.g., all layers including points representing an object) and representing the first object 517 of the second situation 513, and a point cloud included in the plurality of layers including the specific layer and representing the second object 519 of the second situation 513.

According to an exemplary embodiment of the present disclosure, the second object 507 in the first situation 501 may move to the position of the second object 519 in the second situation 513 as time passes.

FIG. 6 illustrates an example of determination for identifying whether an object is occluding another object or is occluded by another object when external points do not overlap each other, in an object recognition apparatus or an object recognition method according to an exemplary embodiment of the present disclosure.

Referring to FIG. 6, in a first situation 601, the processor of the object recognition apparatus may identify a first object 605 of the first situation 601 and a second object 607 of the first situation 601 based on a point cloud obtained through a first LiDAR 603. The processor of the object recognition apparatus may identify that the second object 607 in the first situation 601 is located at the right boundary of a fan-shaped area.

In a second situation 611, the processor of the object recognition apparatus may identify a first object 615, a second object 617, and a third object 619 through a second LiDAR 613. The processor of the object recognition apparatus may identify an occluding object and an occluded object among the first object 615, the second object 617, and the third object 619.

According to an exemplary embodiment of the present disclosure, the processor of the object recognition apparatus may identify a fifth point which is the leftmost point with respect to the host vehicle in a point cloud representing the second object 607 in the first situation 601 and a sixth point which is the rightmost point with respect to the host vehicle in the point cloud representing the second object 607 in the first situation 601.

According to an exemplary embodiment of the present disclosure, the processor of the object recognition apparatus may identify a left angle between a line segment representing the left boundary of the fan-shaped area and a line segment connecting the fifth point and the first LiDAR 603, or identify a right angle between a line segment representing the right boundary of the fan-shaped area and a line segment connecting the sixth point and the first LiDAR 603.

According to an exemplary embodiment of the present disclosure, the processor of the object recognition apparatus may identify that the second object 607 in the first situation 601 is not located at the left boundary based on that the left angle is greater than or equal to a predetermined angle. The processor of the object recognition apparatus may identify that the second object 607 in the first situation 601 is located at the right boundary, based on the right angle being less than or equal to the predetermined angle.

According to an exemplary embodiment of the present disclosure, the processor of the object recognition apparatus may store the ID of the second object 607 of the first situation 601 located at the right boundary in a table. The table may be referred to as a field of view (FOV) list, but embodiments of the present disclosure may not be limited thereto.

According to an exemplary embodiment of the present disclosure, the processor of the object recognition apparatus may identify whether there is an object which is occluding another object or an object which is occluded by another object among the first object 615 of the second situation 611, the second object 617 of the second situation 611, and the third object 619 of the second situation 611.

According to an exemplary embodiment of the present disclosure, the processor of the object recognition apparatus may differently perform a method of identifying whether an object is an occluding object or an occluded object when a first external point and a second external point overlap each other and a method of identifying whether an object is an occluding object or an occluded object when a first external point and a second external point do not overlap each other.

According to an exemplary embodiment of the present disclosure, the processor of the object recognition apparatus may not identify whether at least one of the first object 615 of the second situation 611, and the second object 617 of the second situation 611 is an occluding object or an occluded object based on identifying that an angle (e.g., 01) between a straight line connecting the first external point of the first object 615 of the second situation 611 and the second LiDAR 613 and a straight line connecting the second external point of the second object 617 of the second situation 611 and the second LiDAR 613 is greater than or equal to a threshold angle, when the first external point of the first object 615 of the second situation 611 and the second external point of the second object 617 of the second situation 611 do not overlap each other.

According to an exemplary embodiment of the present disclosure, the processor of the object recognition apparatus may identify whether at least one of the second object 617 of the second situation 611 and the third object 619 of the second situation 611 is an occluding object or an occluded object based on identifying that an angle (e.g., 02) between a straight line connecting the first external point of the second object 617 of the second situation 611 and the second LiDAR 613 and a straight line connecting the second external point of the third object 619 of the second situation 611 and the second LiDAR 613 is less than or equal to the threshold angle, when the first external point of the second object 617 of the second situation 611 and the second external point of the third object 619 of the second situation 611 do not overlap each other.

For example, the processor of the object recognition apparatus may identify, as being an occluded object, the third object 619, which is one of the second object 617 in the second situation 611 and the third object 619 in the second situation 611, corresponding to an external point forming a longer distance among a distance between the first external point of the second object 617 of the second situation 611 and the second LiDAR 613 and a distance between the second external point of the third object 619 of the second situation 611 and the second LiDAR 613. The processor of the object recognition apparatus may identify, as being an occluding object, the second object 617 which is different from an object identified as being an occluded object among the second object 617 of the second situation 611 and the third object 619 of the second situation 611.

A method by which the processor of the object recognition apparatus according to an exemplary embodiment identifies whether at least one of the second object 617 of the second situation 611 and the third object 619 of the second situation 611 is an occluding object and an occluded object when the first external point of the second object 617 of the second situation 611 and the second external point of the third object 619 of the second situation 611 overlap each other will be described with reference to FIG. 7.

The processor of the object recognition apparatus may store the relationship of an occluding object and an occluded object in a table. The table may be referred to as an occlusion map, but embodiments of the present disclosure may not be limited thereto. The processor of the object recognition apparatus may assign a specified first value (e.g., about 1) to rows and columns of the table corresponding to objects that are occluded objects. The processor of the object recognition apparatus may assign a second value (e.g., about −1) to the rows and columns of the table corresponding to objects that are occluding objects. The processor of the object recognition apparatus may assign a third value (e.g., about 0) to the rows and columns of the table corresponding to objects that are neither occluding objects nor occluded objects.

FIG. 7 illustrates an example of determination for identifying whether an object is occluding another object or is occluded by another object when external points overlap each other, in an object recognition apparatus or an object recognition method according to an exemplary embodiment of the present disclosure.

Referring to FIG. 7, in a first situation 701, a first external point of a first object 705 of the first situation 701 and a second external point of a second object 707 of the first situation 701, which are identified through a first LiDAR 703, may overlap each other.

In a second situation 711, the processor of the object recognition apparatus may identify that the first external point of a first object 715 and the second external point of a second object 717, which are identified through a second LiDAR 713, overlap each other. The processor of the object recognition apparatus may identify whether the first object 715 or the second object 717 is an object which is occluding another object or is being occluded by another object based on a distance from a straight line connecting a first point of the first object 715 and a second point of the first object 715 to the second LiDAR 713, and a distance from a straight line connecting a third point of the second object 717 and a fourth point of the second object 717 to the second LiDAR 713 in the second situation 711.

In a third situation 721, the processor of the object recognition apparatus may identify that a first external point of a first object 725 and a second external point of a second object 727, identified via a third LiDAR 723 overlap each other. The processor of the object recognition apparatus may identify whether the first object 725 or the second object 727 is an object which is occluding another object or is being occluded by another object based on a distance to the third LiDAR 723 from a point where a straight line connecting a first point of the first object 725 and the third LiDAR 723 and a straight line connecting the third point and fourth point of the second object 727 meet, a distance to the third LiDAR 723 from a point where the straight line connecting the second point of the first object 725 and the third LiDAR 723 and the straight line connecting the third point of the second object 727 and the fourth point of the second object 727 meet, a distance to the third LiDAR 723 from a point where the straight line connecting the third point of the second object 727 and the third LiDAR 723 and the straight line connecting the first point of the first object 725 and the second point of the first object 725 meet, or a distance to the third LiDAR 723 from a point where the straight line connecting the fourth point of the second object 727 and the third LiDAR 723 and the straight line connecting the first point of the first object 725 and the second point of the first object 725 meet.

According to an exemplary embodiment of the present disclosure, in the first situation 701, the processor of the object recognition apparatus may not identify which of the first object 705 and the second object 707 is an occluding object or an occluded object by simply comparing a distance between the first external point of the first object 705 and the first LiDAR 703 and a distance between the second external point of the second object 707 and the first LiDAR 703. This is because the first external point and the second external point overlap each other.

When the processor of the object recognition apparatus identifies an occluding object and an occluded object based simply on comparing the distance between the first external point of the first object 705 and the first LiDAR 703 with the distance between the second external point of the second object 707 and the first LiDAR 703, the processor of the object recognition apparatus may perceive correlation differently from actual correlation.

According to an exemplary embodiment of the present disclosure, in the second situation 711, the processor of the object recognition apparatus may identify that the first external point of the first object 715 in the second situation 711 (e.g., B in the second situation 711) and the second external point of the second object 717 in the second situation 711 (e.g., C in the second situation 711) overlap each other. The processor of the object recognition apparatus may identify, as an object occluded by the first object 715 of the second situation 711, the second object 717 of the second situation 711 corresponding to a longer distance among a distance to the second LiDAR 713 from a straight line connecting the first point of the first object 715 in the second situation 711 (e.g., A in the second situation 711) and the second point of the first object 715 and a distance to the second LiDAR 713 from a straight line connecting the third point of the second object 717 (e.g., C in the second situation 711) and the fourth point of the second object 717 (e.g., D in the second situation 711).

The processor of the object recognition apparatus may identify, as an object occluding the second object 717 of the second situation 711, the first object 715 of the second situation 711 corresponding to a shorter distance among a distance to the second LiDAR 713 from a straight line connecting the first point of the first object 715 in the second situation 711 and the second point of the first object 715 and a distance to the second LiDAR 713 from a straight line connecting the third point of the second object 717 and the fourth point of the second object 717.

According to an exemplary embodiment of the present disclosure, in the third situation 721, the processor of the object recognition apparatus may identify that the first external point of the first object 725 in the third situation 721 (e.g., B in the third situation 721) and the second external point of the second object 727 in the third situation 721 (e.g., C in the third situation 721) overlap each other. The processor of the object recognition apparatus may identify a first projection point (e.g., E in the third situation 721) which is a point where a straight line connecting a first point of the first object 725 in the third situation 721 (e.g., A in the third situation 721) and a third LiDAR 723 and a straight line connecting a third point (e.g., C in the third situation 721) and fourth point (e.g., D in the third situation 721) of the second object 727 in the third situation 721 meet.

The processor of the object recognition apparatus may identify that the distance from the first projection point to the third LiDAR 723 is greater than the distance from the first point of the first object 725 of the third situation 721 to the third LiDAR 723, and the distance from the second point of the first object 725 of the third situation 721 to the third LiDAR 723. The processor of the object recognition apparatus may identify the first object 725 of the third situation 721 as an object which is occluding another object (e.g., the second object 727 of the third situation 721) based on identifying that the distance from the first projection point to the third LiDAR 723 is greater than the distance from the first point of the first object 725 of the third situation 721 to the third LiDAR 723, and the distance from the second point of the first object 725 of the third situation 721 to the third LiDAR 723.

The processor of the object recognition apparatus may identify a second projection point, which is a point where the straight line connecting the first point of the second object 727 of the third situation 721 and the third LiDAR 723 meets the straight line connecting the first point and second point of the first object 725 of the third situation 721.

The processor of the object recognition apparatus may identify the second object 727 of the third situation 721 as an object which is occluded by another object (e.g., the first object 725 of the third situation 721) based on identifying that the distance from the second projection point to the third LiDAR 723 is less than or equal to the distance from the first point of the first object 725 of the third situation 721 to the third LiDAR 723, or less than or equal to the distance from the second point of the first object 725 of the third situation 721 to the third LiDAR 723.

Another method of identifying objects as an occluding object or an occluded object based on identifying that a first external point and a second external point overlap each other will be described below with reference to FIG. 8.

FIG. 8 shows another example of determination for identifying whether an object is occluding another object or is occluded by another object when external points overlap each other, in an object recognition apparatus or an object recognition method according to an exemplary embodiment of the present disclosure.

Referring to FIG. 8, a processor of an object recognition apparatus may identify at least one of a first object 803 and a second object 805 as an occluded object or an occluding object based on identifying that a first external point of the first object 803 obtained through a LiDAR 801 and a second external point of the second object 805 obtained through the LiDAR 801 overlap each other. A first straight line 807 may represent a straight line connecting the first point and the second point of the first object 803.

According to an exemplary embodiment of the present disclosure, the processor of the object recognition apparatus may identify a first point (e.g., point A), a second point (e.g., point B), a third point (e.g., point C), and a fourth point (e.g., point D). The first point may be located to the leftmost with respect to a host vehicle among a point cloud representing the first object 803. The second point may be located to the rightmost with respect to the host vehicle among the point cloud representing the first object 803. The third point may be located to the leftmost with respect to a host vehicle among a point cloud representing the second object 805. The fourth point may be located to the rightmost with respect to a host vehicle among a point cloud representing the second object 805.

According to an exemplary embodiment of the present disclosure, the processor of the object recognition apparatus may identify whether the first object 803 or the second object 805 is an occluded object or an occluding object based on identifying that the first external point (e.g., point B) and the second external point (e.g., point C) overlap each other.

According to an exemplary embodiment of the present disclosure, the processor of the object recognition apparatus may identify the first straight line 807 passing through the first point and the second point according to the coordinates of the first point (e.g., point A) of the first object 803, and the coordinates of the second point (e.g., point B) of the first object 803, based on identifying that the first external point and the second external point overlap each other. The processor of the object recognition apparatus may assign a reliability to the second object 805 as much as the number of the third points of the second object 805 or the fourth points of the second object 805 which are included in an area to which the LiDAR 801 belongs, among two areas separated by the first straight line 807.

The processor of the object recognition apparatus may identify a second straight line passing through the third point and the fourth point, according to the coordinates of the third point of the second object 805 and the coordinates of the fourth point of the second object 805. The processor of the object recognition apparatus may assign a reliability including a different value from the reliability of the second object 805 to the first object 803 as much as the number of the first points of the first object 803 or the second points of the first object 803 which are included in an area to which the LiDAR 801 belongs among the two areas separated by the second straight line passing through the third point and the fourth point.

The processor of the object recognition apparatus may identify the first object 803 with a greater reliability value as an object that occludes another object by comparing the reliability value of the first object 803 and the reliability value of the second object 805. The processor of the object recognition apparatus may identify the second object 805 with a lower reliability value as an object which is occluded by another object by comparing the reliability value of the first object 803 and the reliability value of the second object 805.

FIG. 9 illustrates an example of iterative determination for identifying whether an object is occluding another object or is occluded by another object in an object recognition apparatus or an object recognition method according to an exemplary embodiment of the present disclosure.

Referring to FIG. 9, a first table 901 may represent the IDs of objects located on the left boundary or the right boundary. The first table 901 may be referred to as a field of view (FOV) list, but embodiments of the present disclosure may not be limited thereto.

A second table 911 may represent a correlation of an occluded object and an occluding object. The second table 911 may be referred to as an occlusion map, but embodiments of the present disclosure may not be limited thereto.

In a situation 921, the processor of the object recognition apparatus may identify a first object 925, a second object 926, and a third object 927 through a LiDAR 923.

The processor of the object recognition apparatus may identify the second object 926 as being occluded by the first object 925, which is located on the left boundary or the right boundary by referring to the first table 901 and the second table 911. The processor of the object recognition apparatus may iteratively identify the fourth object occluded by the second object 926 by referring to the first table 901 and the second table 911.

The processor of the object recognition apparatus may assign a first value (e.g., about 1) to the rows and columns of the second table 911 representing occluded objects. The processor of the object recognition apparatus may assign a second value (e.g., about −1) to the rows and columns of the second table 911 representing occluding objects. The processor of the object recognition apparatus may assign a third value (e.g., about 0) to the rows and columns of the second table 911 representing objects that are neither occluding objects nor occluded objects.

According to an exemplary embodiment of the present disclosure, a processor of the object recognition apparatus may identify that the first object 925 is an object that occludes the second object 926 and the second object 926 is an object which is occluded by the first object 925 based on identifying that an angle (e.g., 0) between a line segment connecting the first external point of the first object 925 and the LiDAR 923 and a line segment connecting the second external point of the second object 926 and the LiDAR 923 is less than a threshold angle when the first object 925 and the second object 926 do not overlap each other.

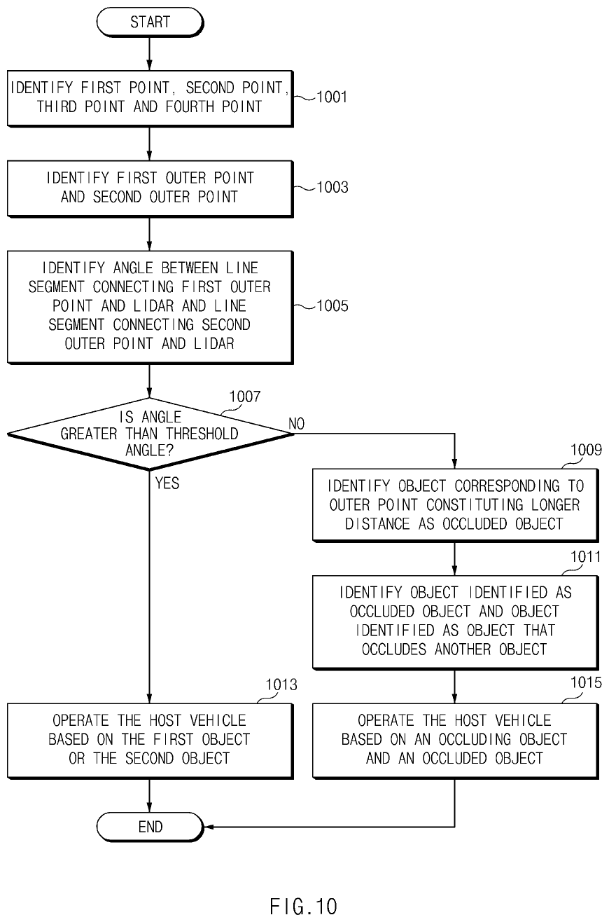

FIG. 10 shows a flowchart of operation of an object recognition apparatus for identifying whether an object is occluding another object or is occluded by another object when external points do not overlap each other, in the object recognition apparatus or the object recognition method according to an exemplary embodiment of the present disclosure.

Hereinafter, it is assumed that the object recognition apparatus 101 of FIG. 1 performs the process of FIG. 10. Additionally, in the description of FIG. 10, operations described as being performed by the object recognition apparatus may be understood as being controlled by the processor 105 of the object recognition apparatus 101.

Referring to FIG. 10, in a first operation 1001, the processor of the object recognition apparatus according to various exemplary embodiments of the present disclosure may identify a first point, a second point, a third point, and a fourth point.

According to an exemplary embodiment of the present disclosure, the processor of the object recognition apparatus may identify, a first point which is the leftmost point with respect to the host vehicle among a point cloud obtained via the LiDAR and representing the first object, a second point which is the rightmost point with respect to the host vehicle among the point cloud representing the first object, a third point which is the leftmost point with respect to the host vehicle among a point cloud representing the second object, and a fourth point which is the rightmost point with respect to the host vehicle among the point cloud representing the second object.

In a second operation 1003, the processor of the object recognition apparatus according to various exemplary embodiments of the present disclosure may identify a first external point and a second external point.

According to an exemplary embodiment of the present disclosure, the processor of the object recognition apparatus may identify a first external point, which is closer to the second object, which is one of the first point and the second point, and a second external point, which is closer to the first object, which is one of the third point and the fourth point.

In a third operation 1005, the processor of the object recognition apparatus according to various exemplary embodiments of the present disclosure may identify an angle between a line segment connecting the first external point and the LiDAR and a line segment connecting the second external point and the LiDAR.

According to an exemplary embodiment of the present disclosure, the processor of the object recognition apparatus may identify an angle between a line segment connecting the first external point and a LiDAR and a line segment connecting the second external point and the LiDAR based on identifying that the first external point and the second external point do not overlap each other.

In a fourth operation 1007, the processor of the object recognition apparatus according to various exemplary embodiments of the present disclosure may identify the angle is greater than a threshold angle. The angle may include an angle between a line segment connecting the first external point and the LiDAR, and a line segment connecting the second external point and the LiDAR. When the angle is not greater than the threshold angle, the processor of the object recognition apparatus may perform a fifth operation 1009. When the angle is greater than the threshold angle, the processor of the object recognition apparatus may not identify an occluding object and an occluded object among the first object and the second object.

In the fifth operation 1009, the processor of the object recognition apparatus according to various exemplary embodiments of the present disclosure may identify an object corresponding to an external point forming a long distance as an occluded object.

According to an exemplary embodiment of the present disclosure, the processor of the object recognition apparatus may identify, as an occluded object, an object which is one of the first object and the second object which corresponds to one of the first external point and the second external point which forms a longer distance among a distance between the first external point and the LiDAR and a distance between the second external point and the LiDAR.

In a sixth operation 1011, the processor of the object recognition apparatus according to various exemplary embodiments of the present disclosure may identify an object identified as an object which is occluded by another object and an object identified as an object that occludes another object.

According to an exemplary embodiment of the present disclosure, the processor of the object recognition apparatus may identify which of the first object and the second object is an object which is occluded by another object or an object that occludes another object.

According to an exemplary embodiment of the present disclosure, when the angle is greater than the threshold angle, the processor of the object recognition apparatus may identify that the first object and the second object do not occlude each other.

In a seventh operation 1013, the processor of the object recognition apparatus according to various exemplary embodiments of the present disclosure may operate the host vehicle based on the first object or the second object.

In an eighth operation 1015, the processor of the object recognition apparatus according to various exemplary embodiments of the present disclosure may operate the host vehicle based on an occluding object and an occluded object.

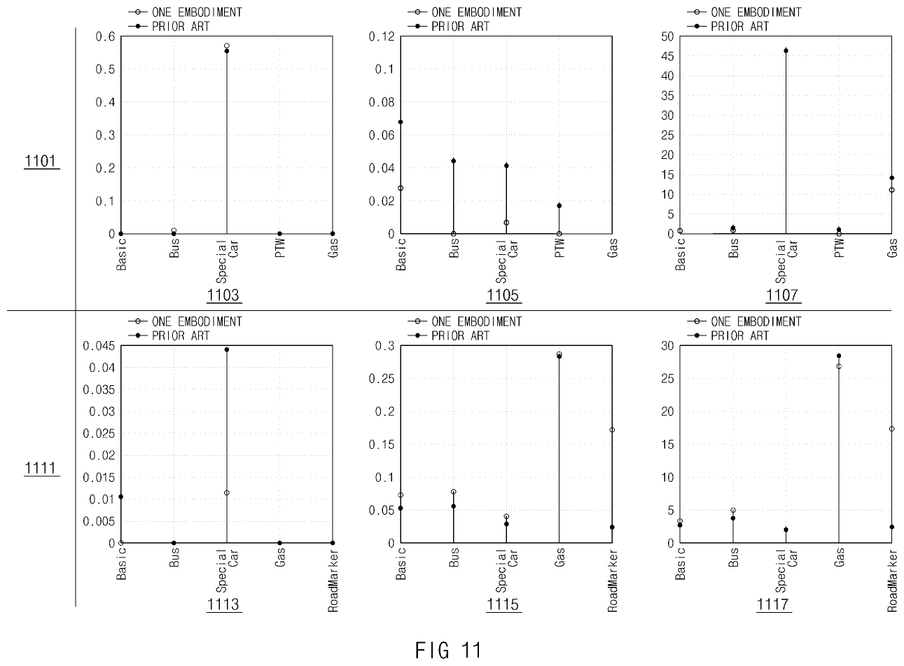

FIG. 11 shows an example of comparing the accuracy of determination for an occluding object identified based on an existing object recognition apparatus or an object recognition method and the accuracy of determination for an occluding object identified based on an object recognition apparatus or an object recognition method according to an exemplary embodiment of the present disclosure.

Referring to FIG. 11, a first graph 1103 in a first row 1101 may show an non-recognition rate of objects identified based on the object recognition apparatus or the object recognition method according to an exemplary embodiment and located on the left boundary of the fan-shaped area or the right boundary of the fan-shaped area and an non-recognition rate of objects identified based on an existing object recognition apparatus or an object recognition method and located on the left boundary of the fan-shaped area, or the right boundary of the fan-shaped area. The non-recognition rate may refer to the rate of failure to identify an object.

According to an exemplary embodiment of the present disclosure, basic may indicate a case where an object is a passenger car. Bus may indicate a case where an object is a bus. Special car may indicate a case where an object is a vehicle such as a tanker or trailer. PTW car may indicate a case where an object is a two-wheeled vehicle such as a motorcycle. Gas may indicate a case where an object is exhaust gas.

The non-recognition rate of the existing object recognition apparatus or the existing object recognition method may not differ by more than about 0.2 from the non-recognition rate of the object recognition apparatus or the object recognition method according to an exemplary embodiment of the present disclosure.

A second graph 1105 in the first row 1101 may show an mis-recognition rate of objects identified based on the object recognition apparatus or the object recognition method according to an exemplary embodiment and located on the left boundary of the fan-shaped area or the right boundary of the fan-shaped area and an mis-recognition rate of objects identified based on an existing object recognition apparatus or an object recognition method and located on the left boundary of the fan-shaped area, or the right boundary of the fan-shaped area. The mis-recognition rate may refer to the rate at which an object is identified as being present when the object is not present.

The mis-recognition rate of the existing object recognition apparatus or the existing object recognition method may be greater than the mis-recognition rate of the object recognition apparatus or the object recognition method according to an exemplary embodiment of the present disclosure.

A third graph 1107 in the first row 1101 may show the average number of errors for objects identified based on the object recognition apparatus or the object recognition method according to an exemplary embodiment and located on the left boundary of the fan-shaped area or the right boundary of the fan-shaped area and the average number of errors for objects identified based on a conventional object recognition apparatus or an object recognition method and located on the left boundary of the fan-shaped area, or the right boundary of the fan-shaped area. The average number of errors may refer to the average number of times the number of frames with an error is identified on average among a specified number of frames (e.g., about 5000).

The average number of errors of the existing object recognition apparatus or the existing object recognition method may be greater than the average number of errors of the object recognition apparatus or the object recognition method according to an exemplary embodiment of the present disclosure.

A fourth graph 1113 in a second row 1111 may show the non-recognition rate of an object identified based on an object recognition apparatus or an object recognition method according to an exemplary embodiment and identified as an occluding object or an occluded object, and the non-recognition rate of an object identified based on an existing object recognition apparatus or an object recognition method and identified as an occluding object or an occluded object. The non-recognition rate may refer to the rate at which an object which is not an occluded object or an occluding object is incorrectly identified as an occluded object or an occluding object.

The non-recognition rate of the existing object recognition apparatus or the object recognition method may be greater than the non-recognition rate of the object recognition apparatus or the object recognition method according to an exemplary embodiment of the present disclosure.

According to an exemplary embodiment of the present disclosure, basic may indicate a case where an object is a passenger car. Bus may indicate a case where an object is a bus. Special car may indicate a case where an object is a vehicle such as a tanker or trailer. Gas may indicate a case where an object is exhaust gas. Road marker may indicate a case where an object is a patch attached to a road.

A fifth graph 1115 in the second row 1111 may show the mis-recognition rate of an object identified based on an object recognition apparatus or an object recognition method according to an exemplary embodiment and not identified as an occluding object or an occluded object, and the mis-recognition rate of an object identified based on an existing object recognition apparatus or an object recognition method and not identified as an occluding object or an occluded object. The mis-recognition rate may refer to the rate at which an occluding object or an occluded object is incorrectly identified as an occluded object or an occluding object.

The mis-recognition rate of the existing object recognition apparatus or the existing object recognition method may not differ by more than about 0.2 from the mis-recognition rate of the object recognition apparatus or the object recognition method according to an exemplary embodiment of the present disclosure.

A sixth graph 1117 in the second row 1111 may show the average number of errors of an object whose characteristics are incorrectly identified based on an object recognition apparatus or an object recognition method according to an exemplary embodiment of the present disclosure, and the average number of errors of an object whose characteristics are incorrectly identified based on an existing object recognition apparatus or an object recognition method. The average number of errors may refer to the number of times the number of frames with an error is identified on average among a specified number of frames (e.g., about 5000).

The average number of errors of the existing object recognition apparatus or the existing object recognition method may not differ by more than about 20 from the average number of errors of the object recognition apparatus or the object recognition method according to an exemplary embodiment of the present disclosure.

According to an exemplary embodiment of the present disclosure, the accuracy of object determination of the existing object recognition apparatus or the existing object recognition method may not be significantly different from the accuracy of object determination of the object recognition apparatus or the object recognition method according to an exemplary embodiment of the present disclosure.

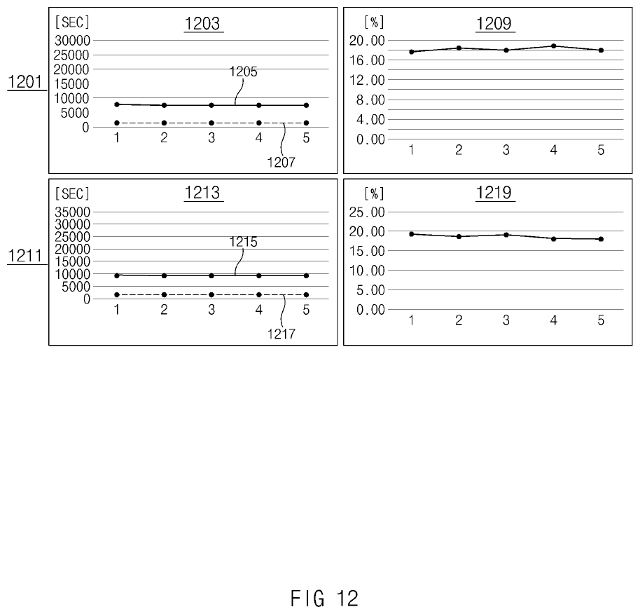

However, the time required for the object recognition apparatus or the object recognition method according to various exemplary embodiments of the present disclosure may be shorter than the time required for the existing object recognition apparatus or the existing object recognition method. The time required for an existing object recognition apparatus or an object recognition method and the time required for an object recognition apparatus or method according to an exemplary embodiment will be described below with reference to FIG. 12.

FIG. 12 shows an example of an amount of computation identified based on an existing object recognition apparatus or an object recognition method and an example of an amount of computation identified based on an object recognition apparatus or an object recognition method according to an exemplary embodiment of the present disclosure.

Referring to FIG. 12, a first graph 1203 in a first row 1201 may show, in a first scenario, a first line 1205 representing central processing unit (CPU) computation time required by an existing object recognition apparatus or an object recognition method and a second line 1207 representing CPU computation time required by an object recognition apparatus or an object recognition method according to an exemplary embodiment of the present disclosure. CPU computation time may refer to the time required for a CPU to process calculations. The first line 1205 and the second line 1207 may represent the CPU computation time required in the first to fifth rounds.

A second graph 1209 in the first row 1201 may show, in the first scenario, the ratio of CPU computation time required by an object recognition apparatus or an object recognition method according to an exemplary embodiment to the CPU computation time required by the existing object recognition apparatus or the existing object recognition method. The second graph 1209 may represent the ratio of CPU computation time consumed in the first to fifth rounds.

A third graph 1213 in a second row 1211 may show, in a second scenario, a third line 1215 representing CPU) computation time required by an existing object recognition apparatus or an object recognition method and a fourth line 1217 representing CPU computation time required by the object recognition apparatus or the object recognition method according to an exemplary embodiment of the present disclosure. The third line 1215 and the fourth line 1217 may represent the CPU computation time required in the first to fifth rounds.

A fourth graph 1219 in the second row 1211 may show, in the second scenario, the ratio of CPU computation time required by an object recognition apparatus or an object recognition method according to an exemplary embodiment to the CPU computation time required by the existing object recognition apparatus or the existing object recognition method.

The fourth graph 1219 may represent the ratio of CPU computation time consumed in the first to fifth rounds.

The first line 1205 and the second line 1207 of the first graph 1203 may indicate that the CPU computation time required in the existing object recognition apparatus or the existing object recognition method is longer than the CPU computation time required by the object recognition apparatus or the object recognition method according to an exemplary embodiment of the present disclosure.

The second graph 1209 may indicate that the CPU time consumed by the object recognition apparatus or the object recognition method according to an exemplary embodiment of the present disclosure is about 19% of the CPU time consumed by the existing object recognition apparatus or the existing object recognition method.

The third line 1215 and the fourth line 1217 of the third graph 1213 may indicate that the CPU computation time required in the existing object recognition apparatus or the existing object recognition method is longer than the CPU computation time required by the object recognition apparatus or the object recognition method according to an exemplary embodiment of the present disclosure.

The fourth graph 1219 may indicate that the CPU time consumed by the object recognition apparatus or the object recognition method according to an exemplary embodiment of the present disclosure is about 19% of the CPU time consumed by the existing object recognition apparatus or the existing object recognition method.

The accuracy of object determination in the object recognition apparatus or the object recognition method according to various exemplary embodiments of the present disclosure may have a difference of less than a reference value from the accuracy of object determination in the existing object recognition apparatus or the existing object recognition method. The CPU time required for the object recognition apparatus or the existing object recognition method according to various exemplary embodiments of the present disclosure may be reduced to about ⅕ times compared to the CPU time required for the existing object recognition apparatus or the existing object recognition method.

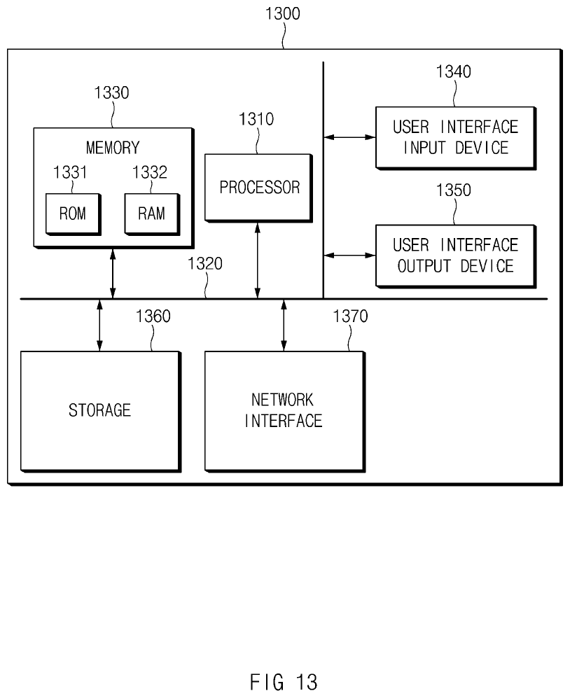

FIG. 13 shows a computing system related to an object recognition apparatus or an object recognition method according to an exemplary embodiment of the present disclosure.

Referring to FIG. 13, a computing system 1300 may include at least one processor 1310, a memory 1330, a user interface input device 1340, a user interface output device 1350, storage 1360, and a network interface 1370, which are connected to each other via a bus 1320.

The processor 1310 may be a central processing unit (CPU) or a semiconductor device that processes instructions stored in the memory 1330 and/or the storage 1360. The memory 1330 and the storage 1360 may include various types of volatile or non-volatile storage media. For example, the memory 1330 may include a Read-Only Memory (ROM) 1331 and a Random Access Memory (RAM) 1332.

Thus, the operations of the method or the algorithm described in connection with the exemplary embodiments disclosed herein may be embodied directly in hardware or a software module executed by the processor 1310, or in a combination thereof. The software module may reside on a storage medium (that is, the memory 1330 and/or the storage 1360) such as a RAM, a flash memory, a ROM, an EPROM, an EEPROM, a register, a hard disk, a removable disk, and a CD-ROM.

The exemplary storage medium may be coupled to the processor 1310, and the processor 1310 may read information out of the storage medium and may record information in the storage medium. Alternatively, the storage medium may be integrated with the processor 1310. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the exemplary embodiment included in an exemplary embodiment of the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may improve the accuracy of determination of whether each of objects is an object that occludes another object or an object which is occluded by another object by comparing distance values for objects represented by a point cloud.

Furthermore, the present technology may improve the accuracy of determination of whether each object is an object that occludes another object or an object which is occluded by another object by comparing reliabilities assigned to objects represented by a point cloud.

Furthermore, the present technology may enhance user experience by improving the accuracy of determination of whether each object is an object that occludes another object or an object which is occluded by another object.

Furthermore, the present technology may improve the performance of autonomous driving or driver assistance driving by improving the accuracy of determination of whether each object is an object that occludes another object or an object which is occluded by another object.

Furthermore, various effects may be provided that are directly or indirectly understood through the present disclosure.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An object recognition apparatus comprising:
a Light Detection and Ranging (LiDAR); and
a processor operatively connected to the LiDAR,
wherein the processor is configured to:
identify a first point which is a leftmost point with respect to a host vehicle among a point cloud obtained through the LiDAR and representing a first object, a second point which is a rightmost point with respect to the host vehicle among the point cloud representing the first object, a third point which is a leftmost point with respect to the host vehicle among a point cloud representing a second object, and a fourth point which is a rightmost point with respect to the host vehicle among the point cloud representing the second object;
identify a first external point, which is closer to the second object, which is one of the first point and the second point, and a second external point, which is closer to the first object, which is one of the third point and the fourth point;
identify an angle between, a line segment connecting the first external point and the LiDAR, and a line segment connecting the second external point and the LiDAR, based on identifying that the first external point and the second external point do not overlap each other;
identify, as an occluded object, an object which is one of the first object and the second object, which corresponds to one of the first external point and the second external point which forms a longer distance among a distance between the first external point and the LiDAR, and a distance between the second external point and the LiDAR, in response that the angle is less than or equal to a threshold angle; and
identify an object different from the object identified as the occluded object among the first object and the second object as an object occluding the occluded object.

2. The object recognition apparatus of claim 1,
wherein the processor is further configured to assign a reliability to the first object, and assign a reliability to the second object with a value different from the reliability assigned to the first object, according to a distance between a straight line connecting the first point and the second point and the LiDAR, and a distance between a straight line connecting the third point and the fourth point and the LiDAR based on identifying that the first external point and the second external point overlap each other, and
wherein the reliability assigned to the first object and the reliability assigned to the second object are configured to indicate whether a corresponding object is an object that occludes another object.

3. The object recognition apparatus of claim 1, wherein the processor is further configured to:
identify a point cloud representing at least one of the first object and the second object identified in a plane formed by a first axis and a second axis among the first axis, the second axis, and a third axis; and
identify whether the first external point and the second external point overlap each other, based on identifying that an azimuth angle of the first external point with respect to an origin corresponding to the LiDAR and the first axis is included in a range between an azimuth angle of the third point with respect to the origin and the first axis and an azimuth angle of the fourth point with respect to the origin and the first axis.

4. The object recognition apparatus of claim 1, wherein the processor is further configured to:
identify a straight line passing through the first point and the second point, according to coordinates of the first point and coordinates of the second point based on identifying that the first external point and the second external point overlap each other;
assign a reliability to the second object as much as a number of the third points or the fourth points included in an area to which the LiDAR belongs among two areas separated by the straight line;
identify a straight line passing through the third point and the fourth point according to coordinates of the third point and coordinates of the fourth point;
assign to the first object a reliability including a different value from the reliability assigned to the second object as much as a number of the first points or the second points which are included in an area to which the LiDAR belongs among two areas separated by the straight line passing through the third point and the fourth point; and
identify an object with a greater reliability value as an object that occludes another object by comparing a value of the reliability of the first object and a value of the reliability of the second object.

5. The object recognition apparatus of claim 1, wherein the processor is further configured to:
identify a first function which is a function of a straight line passing through the first point and the second point, according to coordinates of the first point and coordinates of the second point based on identifying that the first external point and the second external point overlap each other;
assign a reliability to the second object as much as a number of same signs as a sign of a value obtained by substituting coordinates of an origin corresponding to the LiDAR into the first function, among a sign of a value obtained by substituting coordinates of the third point into the first function and a sign of a value obtained by substituting coordinates of the fourth point into the first function;
identify a second function which is a function of a straight line passing through the third point and the fourth point according to the coordinates of the third point and the coordinates of the fourth point;
assign a reliability to the first object as much as a number of same signs as a sign of a value obtained by substituting the coordinates of the origin corresponding to the LiDAR into the second function, among a sign of a value obtained by substituting the coordinates of the first point into the second function and a sign of a value obtained by substituting the coordinates of the second point into the second function; and
identify an object with a greater reliability value as an object that occludes another object by comparing a value of the reliability of the first object and a value of the reliability of the second object.

6. The object recognition apparatus of claim 1, wherein the processor is further configured to:
identify a fan-shaped area including, a point cloud included in a specific layer and representing the first object which is located to leftmost with respect to the host vehicle, and a point cloud included in the specific layer and representing the second object which is located to rightmost with respect to the host vehicle, the fan-shaped area including a minimum center angle with respect to a origin corresponding to the LiDAR; and
expand an area of the fan-shaped area by increasing the center angle of the fan-shaped area to include at least one point located outside the fan-shaped area, based on identifying that the at least one point of a point cloud included in a plurality of layers including the specific layer and representing the first object, and a point cloud included in the plurality of layers including the specific layer and representing the second object is located outside of the fan-shaped area.

7. The object recognition apparatus of claim 1, wherein the processor is further configured to:
identify a fan-shaped area, including a point cloud representing the first object which is located to leftmost with respect to the host vehicle and a point cloud representing the second object which is located to rightmost with respect to the host vehicle, including a minimum center angle with respect to a origin corresponding to the LiDAR;
identify a fifth point located to leftmost with respect to the host vehicle among a point cloud representing a third object and a sixth point located to rightmost with respect to the host vehicle among a point cloud representing the third object;
identify a left angle between a line segment representing a left boundary of the fan-shaped area and a line segment connecting the fifth point and the LiDAR, or a right angle between a line segment representing a right boundary of the fan-shaped area and a line segment connecting the sixth point and the LiDAR; and
identify the third object as being located on the left boundary or as being located on the right boundary based on the left angle or the right angle being less than or equal to a predetermined angle.

8. The object recognition apparatus of claim 1, wherein the processor is further configured to:
identify a point cloud representing the first object among points included in a plurality of layers; and
identify a point cloud representing the second object among the points included in the plurality of layers.

9. The object recognition apparatus of claim 1, wherein the processor is further configured to identify the first external point and the second external point based on an angle between a line segment connecting the first point and the LiDAR and a line segment connecting the third point and the LiDAR, an angle between the line segment connecting the first point and the LiDAR and a line segment connecting the fourth point and the LiDAR, an angle between a line segment connecting the second point and the LiDAR and the line segment connecting the third point and the LiDAR, and an angle between the line segment connecting the second point and the LiDAR and the line segment connecting the fourth point and the LiDAR.

10. The object recognition apparatus of claim 7, wherein the processor is further configured to identify a fourth object occluded by at least one object, and iteratively identify a fifth object occluded by the fourth object based on a table representing the occluded object and the occluding object, and the at least one object located on the left boundary or on the right boundary.

11. An object recognition method comprising:
identifying, by a processor, a first point which is a leftmost point with respect to a host vehicle among a point cloud obtained through a Light Detection and Ranging (LiDAR) and representing a first object, a second point which is a rightmost point with respect to the host vehicle among the point cloud representing the first object, a third point which is a leftmost point with respect to the host vehicle among a point cloud representing a second object, and a fourth point which is a rightmost point with respect to the host vehicle among the point cloud representing the second object;
identifying, by the processor, a first external point, which is closer to the second object, which is one of the first point and the second point, and a second external point, which is closer to the first object, which is one of the third point and the fourth point;
identifying, by the processor, an angle between a line segment connecting the first external point and the LiDAR and a line segment connecting the second external point and the LiDAR based on identifying that the first external point and the second external point do not overlap each other;
identifying, by the processor, as an occluded object, an object which is one of the first object and the second object, which corresponds to one of the first external point and the second external point which forms a longer distance among a distance between the first external point and the LiDAR and a distance between the second external point and the LiDAR, when the angle is less than or equal to a threshold angle; and
identifying, by the processor, an object different from the object identified as the occluded object among the first object and the second object as an object occluding the occluded object.

12. The object recognition method of claim 11, further including:
assigning, by the processor, a reliability to the first object and assigning a reliability to the second object with a value different from the reliability assigned to the first object according to a distance between a straight line connecting the first point and the second point and the LiDAR, and a distance between a straight line connecting the third point and the fourth point and the LiDAR based on identifying that the first external point and the second external point overlap each other,
wherein the reliability assigned to the first object and the reliability assigned to the second object are configured to indicate whether a corresponding object is an object that occludes another object.

13. The object recognition method of claim 11, further including:
identifying, by the processor, a point cloud representing at least one of the first object and the second object identified in a plane formed by a first axis and a second axis among the first axis, the second axis, and a third axis; and
identifying, by the processor, whether the first external point and the second external point overlap each other, based on identifying that an azimuth angle of the first external point with respect to an origin corresponding to the LiDAR and the first axis is included in a range between an azimuth angle of the third point with respect to the origin and the first axis and an azimuth angle of the fourth point with respect to the origin and the first axis.

14. The object recognition method of claim 11, further including:
identifying, by the processor, a straight line passing through the first point and the second point, according to coordinates of the first point and coordinates of the second point based on identifying that the first external point and the second external point overlap each other;
assigning a reliability to the second object as much as a number of the third points or the fourth points included in an area to which the LiDAR belongs among two areas separated by the straight line;
identifying, by the processor, a straight line passing through the third point and the fourth point according to coordinates of the third point and coordinates of the fourth point;
assigning, by the processor, a reliability to the first object including a different value from the reliability assigned to the second object as much as a number of the first points or the second points which are included in an area to which the LiDAR belongs among two areas separated by the straight line passing through the third point and the fourth point; and
identifying, by the processor, an object with a greater reliability value as an object that occludes another object by comparing a value of the reliability of the first object and a value of the reliability of the second object.

15. The object recognition method of claim 11, further including:
identifying, by the processor, a first function which is a function of a straight line passing through the first point and the second point, according to coordinates of the first point and coordinates of the second point based on identifying that the first external point and the second external point overlap each other;
assigning, by the processor, a reliability to the second object as much as a number of same signs as a sign of a value obtained by substituting coordinates of an origin corresponding to the LiDAR into the first function, among a sign of a value obtained by substituting coordinates of the third point into the first function and a sign of a value obtained by substituting coordinates of the fourth point into the first function;
identifying, by the processor, a second function which is a function of a straight line passing through the third point and the fourth point according to the coordinates of the third point and the coordinates of the fourth point;
assigning, by the processor, a reliability to the first object as much as a number of same signs as a sign of a value obtained by substituting the coordinates of the origin corresponding to the LiDAR into the second function, among a sign of a value obtained by substituting the coordinates of the first point into the second function and a sign of a value obtained by substituting the coordinates of the second point into the second function; and
identifying, by the processor, an object with a greater reliability value as an object that occludes another object by comparing a value of the reliability of the first object and a value of the reliability of the second object.

16. The object recognition method of claim 11, further including:
identifying, by the processor, a fan-shaped area including a point cloud included in a specific layer and representing the first object which is located to leftmost with respect to the host vehicle and a point cloud included in the specific layer and representing the second object which is located to rightmost with respect to the host vehicle, the fan-shaped area including a minimum center angle with respect to a origin corresponding to the LiDAR; and
expanding, by the processor, an area of the fan-shaped area by increasing the center angle of the fan-shaped area to include at least one point located outside the fan-shaped area, based on identifying that the at least one point of a point cloud included in a plurality of layers including the specific layer and representing the first object, and a point cloud included in the plurality of layers including the specific layer and representing the second object is located outside of the fan-shaped area.

17. The object recognition method of claim 11, further including:
identifying, by the processor, a fan-shaped area including a point cloud representing the first object which is located to leftmost with respect to the host vehicle and a point cloud representing the second object which is located to rightmost with respect to the host vehicle, including a minimum center angle with respect to a origin corresponding to the LiDAR;
identifying, by the processor, a fifth point located to leftmost with respect to the host vehicle among a point cloud representing a third object and a sixth point located to rightmost with respect to the host vehicle among a point cloud representing the third object;
identifying, by the processor, a left angle between a line segment representing a left boundary of the fan-shaped area and a line segment connecting the fifth point and the LiDAR or a right angle between a line segment representing a right boundary of the fan-shaped area and a line segment connecting the sixth point and the LiDAR; and
identifying the third object as being located on the left boundary or as being located on the right boundary based on the left angle or the right angle being less than or equal to a predetermined angle.

18. The object recognition method of claim 11, wherein the identifying of the first point which is the leftmost point with respect to the host vehicle among the point cloud obtained through the LiDAR and representing the first object, the second point which is the rightmost point with respect to the host vehicle among the point cloud representing the first object, the third point which is the leftmost point with respect to the host vehicle among the point cloud representing the second object, and the fourth point which is the rightmost point with respect to the host vehicle among the point cloud representing the second object includes:
identifying, by the processor, a point cloud representing the first object among points included in a plurality of layers; and
identifying, by the processor, a point cloud representing the second object among the points included in the plurality of layers.

19. The object recognition method of claim 11, wherein the identifying of the first external point, which is closer to the second object, which is one of the first point and the second point, and the second external point, which is closer to the first object, which is one of the third point and the fourth point includes identifying the first external point and the second external point based on an angle between a line segment connecting the first point and the LiDAR and a line segment connecting the third point and the LiDAR, an angle between the line segment connecting the first point and the LiDAR and a line segment connecting the fourth point and the LiDAR, an angle between a line segment connecting the second point and the LiDAR and the line segment connecting the third point and the LiDAR, and an angle between the line segment connecting the second point and the LiDAR and the line segment connecting the fourth point and the LiDAR.

20. The object recognition method of claim 17, further including:
identifying, by the processor, a fourth object occluded by at least one object, and iteratively identify a fifth object occluded by the fourth object based on a table representing the occluded object and the occluding object, and the at least one object located on the left boundary or on the right boundary.
